(19) United States
(12) Patent Application Publication
(10) Pub. No.: US 2010/0083102 A1
(43) Pub. Date: Apr. 1, 2010

(54) Online Content Editing of Dynamic Websites

(76) Inventors: Juan Carlos Jimenez, Campbell, CA (US); David Koski, San Jose, CA (US); Ralph E. Zazula, Mountain View, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/239,506

(22) Filed: Sep. 26, 2008

(51) Int. Cl. G06F 17/22; G06F 17/24

(52) U.S. Cl. 715/255

(57) ABSTRACT

Techniques for improved methods for editing dynamic web pages or other online content are disclosed. In one embodiment, a user, such as an administrator, can access a web page via a local client application (e.g., web browser) and can edit the web page without knowledge of the configuration by which data for the web page is stored at a remote server.

### BACKGROUND OF THE INVENTION

1. Field of the Invention

The invention pertains to editing online content and, more particularly, to editing online content in a client-server environment.

2. Description of the Related Art

Conventially, web pages are created and/or edited using some form of HTML or other markup language editor. Originally, HTML editors were simple text editors, and web pages were created by writing HTML “code,” i.e., by inserting HTML tags into text that could be interpreted by a web browser. More recently, HTML editors have been more user-friendly, some even incorporating What-You-See-Is What-You-Get (WYSIWYG) functionality so that the creator of a web page need not insert HTML tags into a document in order to create a web page. However, WYSIWYG editors are generally limited in functionality, especially when editing more complex documents or large collections of documents such as websites. In the case where a website is dynamic, such as is the case for most commercial websites, website administrators generally rely on an intimate knowledge of the infrastructure of the data structures that are used to create web pages on demand (dynamically). For example, many dynamically created web pages are constructed using data structures stored in databases and/or file systems. Modification of these data structures generally requires an understanding of the syntax and/or organization of the stored data. Put another way, modification of these data structures requires an understanding of the “back-end” of the web page creation process. In computer programming parlance, a back end is a part of a software or hardware system that is hidden (and often remote) from the user. Conversely, a front end is a part of a software or hardware system that a user interacts with. For example, graphical user interfaces are sometimes described as “front-ends”.

Requiring that every website administrator have detailed knowledge of the back end of a website is burdensome and often not feasible. Thus, there is a need for website administration tools that reduce or eliminate the need for extensive knowledge of how or where online content is stored.

### SUMMARY OF THE INVENTION

The invention pertains to techniques for improved methods for editing dynamic web pages or other online content. In one embodiment, a user, such as an administrator, can access a web page via a local client application (e.g., web browser) and can edit the web page without knowledge of the configuration by which data for the web page is stored at a remote server.

The invention can be implemented in numerous ways, including as a method, system, device, or apparatus (including a computer readable medium or a graphical user interface). Several embodiments of the invention are discussed below.

As a method for modifying a web page provided by a web server, where content for the web page is stored at least in part in a content database, one embodiment of the invention can, for example, include at least: obtaining, from the web server, web page data and administrative data for at least one component of the web page, the web page data and the administrative data being stored in the content database; editing the web page so as to modify the administrative data for the at least one component of the web page; and submitting, to the web server, the edited web page including the modified administrative data for the at least one component of the web page.

As a method for modifying a web page provided by a web server with content for the web server being stored at least in part to a content database, another embodiment of the invention can, for example, include at least: accessing web page data and administrative data for at least one component of the web page, the web page data and the administrative data being stored in the content database; subsequently receiving modified administrative data for the at least one component of the web page after the web page has been modified; and updating the content database in view of the modified administrative data for the at least one component of the web page.

As a computer-implemented method for editing a web page, one embodiment of the invention can, for example, include at least: receiving a request from a requester for a web page; obtaining web page data and stored administrative information for the requested web page, the web page having a plurality of components; sending the web page data and the stored administrative information to the requester; subsequently receiving a web page edit submission to at least one of the components of the web page, the web page edit submission includes at least modified administrative information pertaining to the at least one of the components of the web page; and updating the stored administrative information pertaining to the web page based on the modified administrative information pertaining to the at least one of the components of the web page.

As a method for editing a web page, one embodiment of the invention can, for example, include at least: requesting a web page from a web server; receiving the web page from the web server, the web page having a plurality of components; presenting the web page; receiving administrative information pertaining one or more of the components of the web page; receiving a selection of one of the components of the web page; determining an appropriate editor for the selected component of the web page based on the administrative information pertaining to the selected component; and accessing the appropriate editor to alter the selected component of the web page.

As a computer-implemented method for editing a web page on a client computer, one embodiment of the invention can, for example, include at least: requesting a web page from a web server; receiving the web page from the web server; receiving administrative information pertaining to the web page from the web page; displaying the web page at the client computer; interacting with the displayed web page to edit the web page; modifying the administrative information based on the edit to the web page; and submitting the edited web page to the web server, including sending the modified administrative information to the web server.

As a computer readable medium including at least executable computer program code tangibly stored thereon for modifying a web page provided by a web server, where content for the web page is stored at least in part in a content database, one embodiment of the invention can, for example, include at least: computer program code for obtaining, from the web server, web page data and administrative data for at least one component of the web page, the web page data and the administrative data being stored in the content database; computer program code for editing the web page so as to modify the administrative data for the at least one component of the web page; and computer program code for submitting, to the web server, the edited web page including the modified administrative data for the at least one component of the web page.

As a computer readable medium including at least executable computer program code tangibly stored thereon for editing a web page, one embodiment of the invention can, for example, include at least: computer program code for receiving a request from a requestor for a web page; computer program code for obtaining web page data and stored administrative information for the requested web page, the web page having a plurality of components; computer program code for sending the web page data and the stored administrative information to the requester; computer program code for subsequently receiving a web page edit submission to at least one of the components of the web page, the web page edit submission includes at least modified administrative information pertaining to the at least one of the components of the web page; and computer program code for updating the stored administrative information pertaining to the web page based on the modified administrative information pertaining to the at least one of the components of the web page.

As a website content delivery and management system, one embodiment can, for example, include at least: a front-end sender configured to receive page requests for web pages via a network; and a content database configured to store content for a plurality of web pages as well as administrative information pertaining to a plurality of components of the web pages. In response to a particular page request, the front-end server can return not only content for the particular web page retrieved from the content database but also administrative information associated with the particular web page. The administrative information for the particular webpage can be used to facilitate editing the particular web page.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a website content delivery and management system according to one embodiment of the invention.

FIG. 2 is a flow diagram of a web page modification process according to one environment of the invention.

FIG. 3 is a flow diagram of a web page content management process according to one embodiment of the invention.

FIG. 4A is a flow diagram of a web page annotation process according to one embodiment of the invention.

FIG. 4B is a flow diagram of a web page edit process according to one embodiment of the invention.

FIG. 4C is a flow diagram of administrative information display process according to one embodiment of the invention.

FIG. 5 is an example of a database organizational scheme used to store web content according to one embodiment of the invention.

FIGS. 6(a) and 6(b) are examples of exemplary web pages according to different usage scenarios.

FIG. 7 is a block diagram of an exemplary client-server system for editing online content according to one embodiment of the invention.

FIGS. 8(a) and 8(b) illustrate representative administrative information for a portion of a web page according to one embodiment of the invention.

### DETAILED DESCRIPTION OF THE INVENTION

The invention pertains to techniques for improved methods for editing dynamic web pages or other online content. In one embodiment, a user, such as an administrator, can access a web page via a local client application (e.g., web browser) and can edit the web page without knowledge of the configuration by which data for the web page is stored at a remote server.

In one embodiment, administrators can edit web pages using a client application that causes a server application to update content data and/or configuration information remotely stored at a back-end. Advantageously, the administrators need not understand how or where the content data and/or the configuration information is stored at the back-end. In another embodiment, a client application can cause an appropriate edit program to activate when a user identifies a particular component of a web page to be edited. In still embodiment, a particular component of a web page to be edited can be designated by an administrator and then at least a portion of configuration information associated with the particular component can be presented to the administrator.

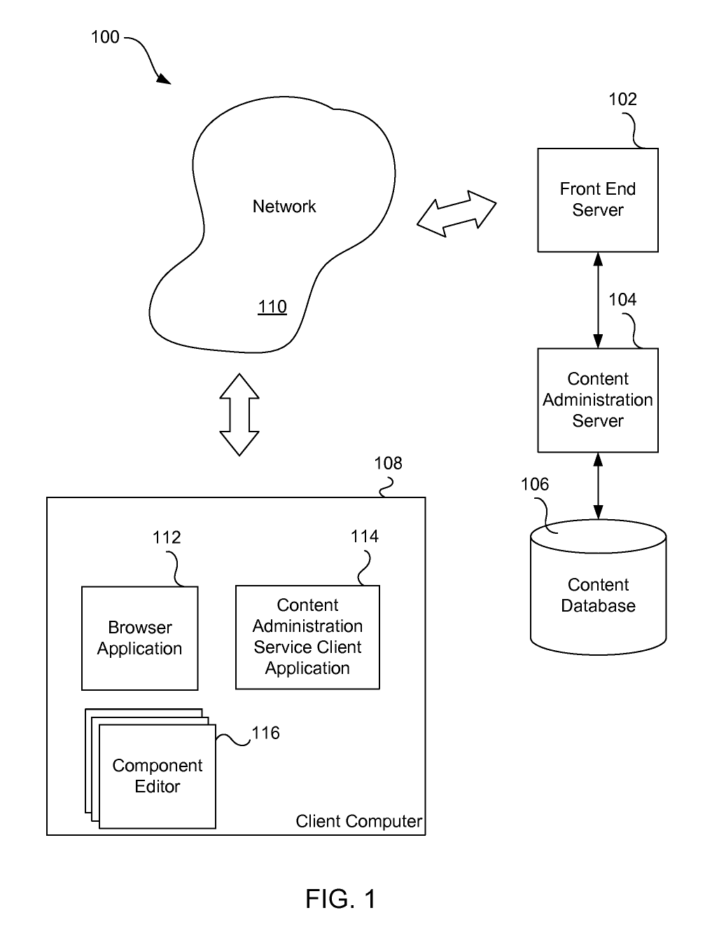

Embodiments of various aspects of the invention are discussed below with reference to FIGS. 1-8(b). However, those skilled in the art will readily appreciate that the detailed description given herein with respect to these figures is for explanatory purposes as the invention extends beyond these limited embodiments.

FIG. 1 is a block diagram of a website content delivery and management system 100 according to one embodiment of the invention. The website content delivery and management system 100 can be used to make content for websites (having one or more pages) available online (i.e., “online content”).

The website content delivery and management system 100 includes a front end server 102. The front end server 102 can also be referred to as a web server. The front end server 102 operates to respond to web page requests from various requesters as well as to provide content management capabilities to authorized administrators. In one embodiment, an administrator, for example a website administrator, can use a proprietary online content administration tool to interact with the front end server 102. In another embodiment, a standard web browser can be used. The administrator can be identified via a login process, for example. Other authentication/identification methods can be used to determine whether a particular user or administrator is authorized to receive enhanced online content.

The website content delivery and management system 100 also includes a content administration server 104. The content administration server 104 manages content being utilized by one or more web pages associated with one or more websites, with each of the websites including one or more web pages. In doing so, the content administration server 104 interacts with a content database 106 that provides storage for web page data (e.g., content and layout), metadata and/or administrative configuration information. Administrative configuration information is information as to how or where online content is stored (e.g., in content database 106). In one embodiment, the administrative configuration information provides node, slot and type for the components of each web page.

The website content delivery and management system 100 supports a client computer 108 that is capable of coupling to a network 110. The network 110 can pertain to a data network, such as a Local Area Network (LAN), a Wide Area Network (WAN) or the Internet. The client computer 108, when coupled to the network 110, is able to interact with the front end server 102 which is also coupled to the network 110. Although FIG. 1 illustrates only a single client computer 108, it should be recognized that the website content delivery and management system 110 can support a significant number of distinct client computers. Client computers can represent desktop computers, personal computers, notebook computers, personal digital assistants, portable computing devices, mobile telephones with computing capabilities, and the like.

The client computer 108 illustrated in FIG. 1 can include a browser application 112 that allows the client computer 108 to interact with the front-end server 102. The browser application 112 can be a separate application, such as a web browser, or can represent non-browser program that incorporates browser functionality (e.g., iTunes™ application available from Apple Inc.). More generally, the browser application 112 can be considered a user agent. In addition, the client computer 108 can include a content administration service client application which enables the client computer 108 to interact with the content administration server 104. In the implementation illustrated in FIG. 1, the client computer 108 can interact with the content administration server 104 via the front end server 102. However, in alternative environments, the client computer 108 can interact more directly with the content administration server 104. Still further, the client computer 108 can include a plurality of component editors 116. The component editors 116 represent different editors for different types of components that can be utilized with web pages. Example of different types of components can include: image (e.g., image grid), text, HTML, text translation, link list, style sheet, layout. Examples of component editors can include: an image grid editor (e.g., changing or repositioning images), linked list editors, web page layout editors, style sheet editors, free-form HTML editors, and text translation editors (e.g., designate a language to be used). In one implementation, the component editors 116 can be integrated into the browser application 112.

According to one aspect, a user of the client computer 108 that has adequate administration privileges can utilize the client computer 108 to alter at least a portion of one or more web pages of a website whose content (often dynamic content) is being managed by the content administration server 104. In doing so, the user can utilize the browser application 112 to access a web page to be modified using the network 110 just as any other user might access the web page. However, since the particular user has administration privileges and is desirous of editing the web page, the content administration server 104 together with the assistance of the front-end server 102 can provide not only the web page but also administrative configuration information pertaining to the web page of interest to the user. The administrative configuration information can assist the user at the client computer 108 to identify data structures and/or storage locations for one or more web page components that are to be modified. In one implementation, the administrative configuration information is embedded in the web page being provided to the user (administrator). In this case, the web page can be considered annotated or enhanced since it includes the administrative configuration information. In another implementation, the administrative configuration information is provided to the user separate from the web page. For example, a separate request could be made to request the administrative configuration information associated with the web page.

The administrative configuration information can, for example, facilitate selection of one of the component editors 116 that is suitable for use in modifying one or web page components of the web page. For example, the administrative configuration information can indicate a type of web page component which can be used to determine the appropriate editor. To the extent different editors are needed for different web page components, multiple different component editors 116 can be made available. Following the user utilizing the appropriate editor to modify the one or more web page components for the web page to be modified, the modifications to the web page can be submitted to the content administration server 104 by way of the network 110 and the front-end server 102. The content administration server 104 can then operate to store the updated content for the particular web page to the content database 106. In this regard, in one implementation, the administrative configuration information can be modified at the client computer 108, such as by the content administration service client application 114, to reflect the modifications to the web page (e.g., one or more web page components). When the modified web page is then submitted back the content administration server 104, the modified administrative configuration information can be provided to the content administration server 104 so that not only can the corresponding data structure and/or data storage location be located but also the administrative configuration information for the web page can be updated in the content database 106 to reflect the modifications.

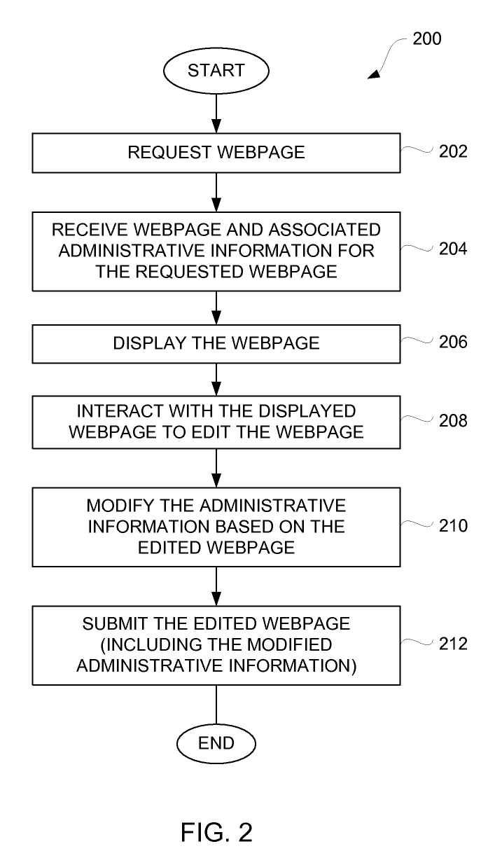

FIG. 2 is a flow diagram of a web page modification process 200 according to one environment of the invention. The web page modification process 200 can, for example, be performed by a client machine, such as the client computer 108 illustrated in FIG. 1.

The web page modification process 200 can initially request 202 a web page. For example, a user (requestor) can utilize the browser application 112 to request (i.e., access) the web page. In response to the request 202, the requested web page as well as associated administrative information can be received 204. The requested web page can include the associated administrative information. Alternatively, the associated administrative information can received separate from the requested web page (such as in response to another request). The web page can then be displayed 206. After the web page has been displayed 206, a user of the client machine can interact 208 with the displayed web page to edit the web page. In editing the web page, the user can alter the content and/or arrangement of the web page. In doing so, the administrative information can also be modified to 910 based on the edited web page. For example, if the web page has been edited to change an image appearing on the web page from a first image to a second image, the administrative information can be modified 210 to link to the second image instead of the first image. Although the user edits the web page, the client computer 108, namely, the browser application 112 and/or the content administration service client application 114, can modify the administrative information in response to the user edits.

After the administrative information has been modified 210, the edited web page (including the modified administrative information) can be submitted 212 to a remote server. For example, the remote server can pertain to the front-end server 102 and/or the content administration server 104 illustrated in FIG. 1. Following the submission 212 of the edited web page, the web page modification process 210 can end.

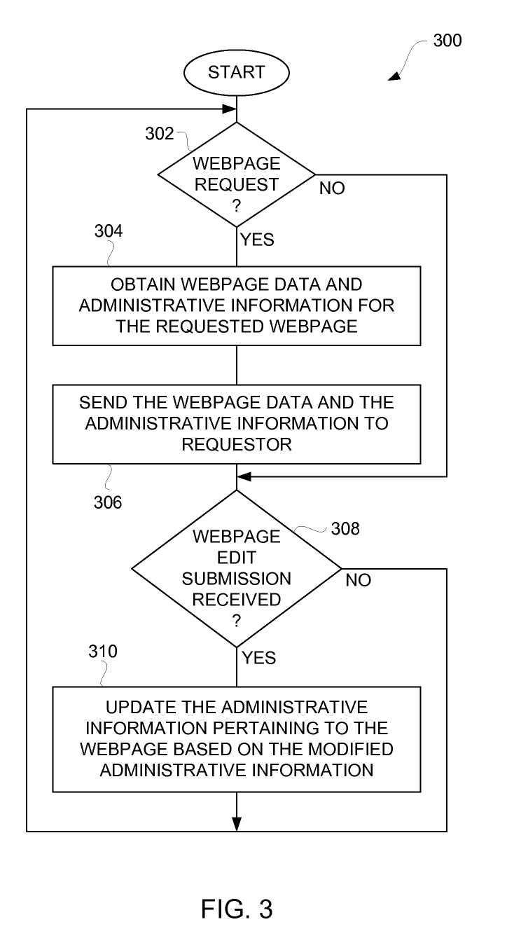

FIG. 3 is a flow diagram of a web page content management process 300 according to one embodiment of the invention. The web page content management process 300 is, for example, performed by a server computer, such as the front-end server 102 and/or the content administration server 104 illustrated in FIG. 1.

The web page content management process 300 can begin with a decision 302 that determines whether a web page request has been received. When the decision 302 determines that a web page request has been received, web page data and administrative information for the requested web page can be obtained 304. The web page data and the administrative information can then be sent 306 to the requestor. For example, the web page request can be an HTTP request for a web page and in the response can be a HTTP response that returns the web page data as well as the administrative information to the requestor. In one implementation, and the web page data and the administrative information are provided to the requester in the same response. In another implementation, the web page and the administrative information are provided to the requestor in different responses. Alternatively, when the decision 302 determines that a web page request has not been received, the blocks 304 and 306 can be bypassed.

Following the block 306, or its being bypassed, a decision 308 can determine whether a web page edit submission has been received. When the decision 308 determines that a web page edit submission has been received, the administrative information pertaining to the web page can be updated 310 based on the modified administrative information. Here, the web page edit submission can be parsed to acquire at least the modified administrative information. For example, if the server machine utilizes a content database 106 to maintain the web page data and administrative information for various web pages, then the content database 106 can be updated to include the modified administrative information. Also, the web page edit request could also include modified content data which can be similarly acquired from parsing and then stored to the content database 106.

Alternatively, if the decision 308 determines that a web page edit submission has not been received, the block 310 can be bypassed. In any case, following the block 310, or its being bypassed, the web page content management process 300 can return to repeat the decision 302 so that a subsequent web page request can be similarly processed.

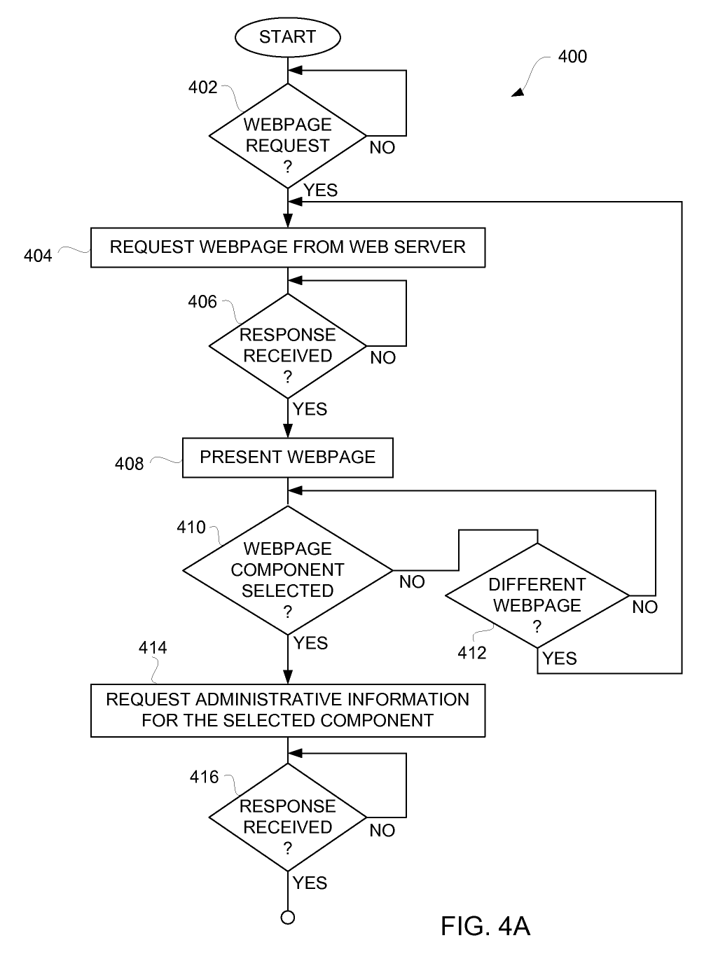

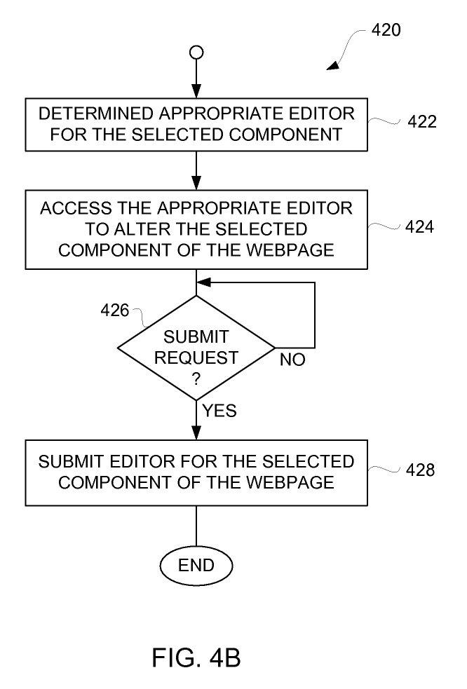

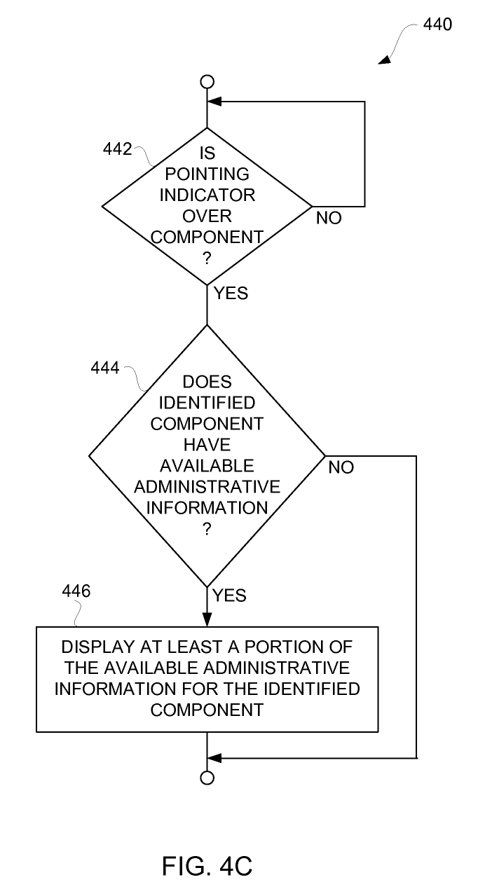

FIG. 4A is a flow diagram of a web page annotation process 400 according to one embodiment of the invention. The web page annotation process 400 is, for example, performed at a client machine, such as the client computer 108 illustrated in FIG. 1.

The web page annotation process 400 can begin with a decision 402 that determines whether a web page request has been received. When the decision 402 determines that a web page request has not been received, the web page annotation process 400 awaits such a request. In other words, the web page annotation process 400 can be invoked when a web page request is received. Hence, when the decision 402 determines that a web page request has been received, the web page can then be requested 404 from a web server. For example, the web server can correspond to the front end server 102 illustrated in FIG. 1.

After the web page has been requested 404, a decision 406 determines whether a response to the web page request has been received. When the decision 406 determines that a response has not yet been received, the web page annotation process 400 can await such a response. On the other hand, when the decision 404 determines that a response to the web page request has been received, the web page can be presented 408. Typically, the web page can be presented 408 by displaying the web page at the client computer.

Next, a decision 410 determines whether a web page component has been selected. Here, the web page being presented 408 constitutes a plurality of web page components. The decision 410 determines whether the user of the client computer has operated to select one of the web page components. For example, in the processing of editing webpage, the user can select a web page component to be edited. When the decision 410 determines that a web page component has not been selected, a decision 412 can determine whether a different web page is to be requested. When the decision 412 determines that a different web page should be requested, the web page annotation process 400 returns to repeat the block 404 so that another web page can be similarly processed. Alternatively, when the decision 412 determines that a different web page should not be requested, the web page annotation process 400 returns to repeat the decision 410 to again determine whether a web page component has been selected.

On the other hand, when the decision 410 determines that a web page component has been selected, administrative information for the selected component can be requested 414. As an example, as shown in FIG. 1, administrative information for various components can be stored in the content database 106 which can be managed by the content administration server 104. Hence, the request for the administrative information can be served by the content administration server 104. Next, a decision 416 determines whether a response to the request 414 has been received. When the decision 416 determines that a response is not yet been received, the web page annotation process 400 awaits such a response. Once the decision 416 determines that a response has been received, the web page annotation process 400 can provide further processing to carry out operations on the web page, such as editing, displaying or saving website data and/or administrative information, etc.

FIG. 4B is a flow diagram of a web page edit process 420 according to one embodiment of the invention. The web page edit process 420 is additional processing that can be performed to edit a web page. The web page edit process 420 can follow from the web page annotation process 400 illustrated in FIG. 4A. In particular, the web page edit process 420 can, for example, determine 422 an appropriate editor for the selected component. Then, the appropriate editor can be accessed 424 to alter the selected component of the web page. Next, a decision 426 can determine whether a submit request is received. For example, a user can interact with the appropriate editor to make and edit the web page. When the user is done with editing, the user can submit the edits. When the decision 426 determines that a submit request has not yet been received, the web page edit process 420 can await a submit request. Alternatively, when the decision 426 determines that an edit has been received, the edits for the selected component of the website can be submitted 428. Following the block 428, the web page edit process 420 can end.

FIG. 4C is a flow diagram of administrative information display process 440 according to one embodiment of the invention. In one embodiment, the administrative information display process 440 can follow from the web page annotation process 400 illustrated in FIG. 4A.

The administrative information display process 440 can begin with a decision 442. The decision 442 can determine whether a pointing device is over a component of the web page being presented (e.g., displayed) at the client computer. The pointing device is, for example, a device, such as a mouse, track ball or touchpad, that controls movement of a pointing indicator (e.g., cursor) being displayed on the display device of the client computer. When the decision 442 determines that there is no pointing indicator over the component, the administrative information display process 440 waits until a pointing indicator is provided over a component of the web page. In other words, the administrative information display process 440 can be deemed to be invoked once a pointing indicator is provided over a component of the web page. Alternative, if the pointing device is a touch surface, such as a touch screen, the pointing indicator can then be represented by the user's finger or a stylus.

In any case, when the decision 442 determines that a pointing indicator is provided over a component of the web page, a decision 444 can determine whether the identified component has available administrative information. When the decision 444 determines that the identified component of the web page does have available administrative information, at least a portion of the available administrative information can be displayed 446 for the identified component. Alternatively, when the identified component does not have available administrative information, the block 446 can be bypassed. Following the block 446, or its being bypassed, the administrative information display process 440 can end. However, the administrative information display process 440 can also repeat or invoked whenever a pointing indicator is provided over a component.

In one embodiment, the speed the responsiveness of the client machine to the administrative information display process 440, the client machine can in advance acquire administrative information for all the components of the webpage being presented. In doing so, the client machine can cache, index or otherwise store the administrative information at the client machine such that it can be rapidly retrieved. Consequently, a the pointing indicator is navigated over a component of the webpage, at least a portion of the administrative information can be rapidly access from the local cache, index or other storage and presented to the user.

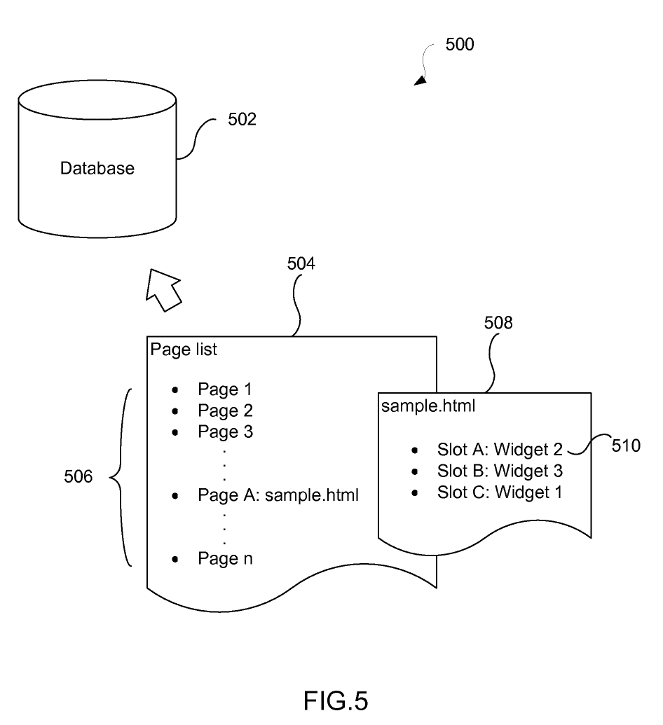

FIG. 5 is an example of a database organizational scheme 500 used to store web content according to one embodiment of the invention. The web content can pertain to content for web pages of a website. The database organizational scheme 500 is simplified for purposes of illustration. The database organizational scheme 500 depicts database 502 including a page list 504 of page nodes 506. The page nodes can represent web pages or other online content elements. Of interest in the page list 504 is page node 508 (“Page A”), which depicts a particular web page (“sample.html”). The page node 508 is shown as containing three slots 510, with each slot containing a web page component. The web page component can, for example, represent text, image, animation, video, etc. The page nodes 506 can also contain layout information and/or administrative configuration information. The layout information and/or administrative configuration information for the page nodes 506 can be described or represented in the form of XML, HTML or other markup. In the example shown in FIG. 5A, with respect to the page node 508, Slot A is shown as containing component 2, slot B is shown as containing component 3, and slot C is shown containing component 1. Note that any number of components can be contained in a slot and that each slot can also contain configuration information (e.g., layout information or administrative configuration information). Also note that, while page node 508 is shown with three (3) slots, any number of slots can be contained in a node (e.g., web page).

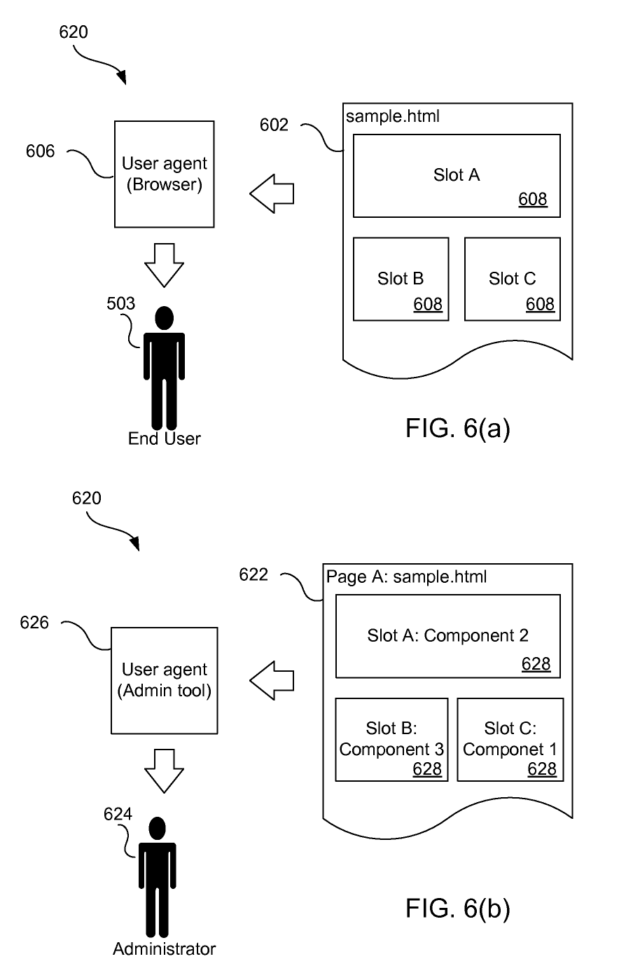

FIGS. 6(a) and 6(b) are examples of exemplary web pages according to different usage scenarios. FIGS. 6(a) and 6(b) can be constructed using the information depicted in FIG. 5, including configuration, slot, and component information.

FIG. 6(a) depicts a usage scenario 600 according to one embodiment. The usage scenario 600 allows a web page 602 (“sample.html”) to be accessed by an end user 604. More particularly, the end user 604 can use a user agent (e.g., web browser) 606 to access the web page 602. The end user 604 is thus able to view the web page 602 using the user agent 606. This usage scenario 600 is a common occurrence in the modern Internet era. In this embodiment, the web page 602 as depicted in FIG. 6(a) has three slots 608 (i.e., web page components), namely, slot A, slot B and slot C. In addition, the web page 604 has a layout, which is typically described in terms of a markup language such as HTML or XML. Each of the slots 608 can contain some data item that can be found on a web page, such text, image (graphic), animation, video, etc.

FIG. 6(b) depicts a usage scenario 620 according to another embodiment. The usage scenario 620 allows a web page 622 (sample.html) to be accessed by an end user 624. More particularly, the end user 624 can use a user agent (e.g., web browser) 626 to access the web page 622. The end user 624 is thus able to view the web page 622 using the user agent 626. However, in this embodiment, the end user is an administrator and the user agent 626 operates as an administration tool, though the user agent 626 may still be a web browser. In one implementation, the administration tool is a WYSIWYG (What-You-See-Is What-You-Get) web page editing tool.

In FIG. 6(b), the web page 622 can represent an enhanced version of the web page 602 shown in FIG. 6(a). The web page 622 has the same layout and content as web page 602. However, web page 622 is enhanced (or annotated) to provide additional information (e.g., administrative information) that is useful to the end user 626 (administrator). The additional information includes information detailing type of components and or how or where the components of the web page 622 are stored in a database (e.g., the database 502 illustrated in FIG. 5. Specifically, note that instead of merely displaying “sample.html” at the top of the web page 622, the web page 622 can display additional information about where “sample.html” is stored. Thus, “sample.html” can become “Page A:sample.html”. “Page A” could refer to a path, a table, or to other information that details where sample.html is found in the database 502. Additionally or alternatively, each or a selected one of the components on the web page 622 can display information about its type and/or how or where each component is stored in the database 502.

In this embodiment, the web page 622 as depicted in FIG. 6(b) has three slots 628 (i.e., web page components), namely, slot A, slot B and slot C. In addition, the web page 624 has a layout, which is typically described in terms of a markup language such as HTML or XML. Each of the slots 628 can contain some data item that can be found on a web page, such text, image (graphic), animation, video, etc. Each of the slots 628 can also contain information (e.g., annotations) indicating where the data items for the respective slots are stored in the database 502.

Accordingly, the end user 624 (administrator) by using the user agent 626 can view and/or edit the web page 622. In the case of editing the web page 622, the additional information contained in the web page 622 can advantageously free the end user 624 from needing to have an intimate knowledge of how database 502 is organized.

In one embodiment, the additional information (e.g., annotations) concerning the components in the slots 628 contained in web page 622 can be displayed to the end user 624 (administrator) when a pointing device (e.g., cursor via mouse control) of the client computer is positioned over one of the slots 628. For example, in this regard, the additional information being displayed can be (i) type of component, and/or (ii) how or where component is remotely stored. Alternately, the additional information can be displayed directly on a particular component or in a separate user-interface window for use by the end user 624.

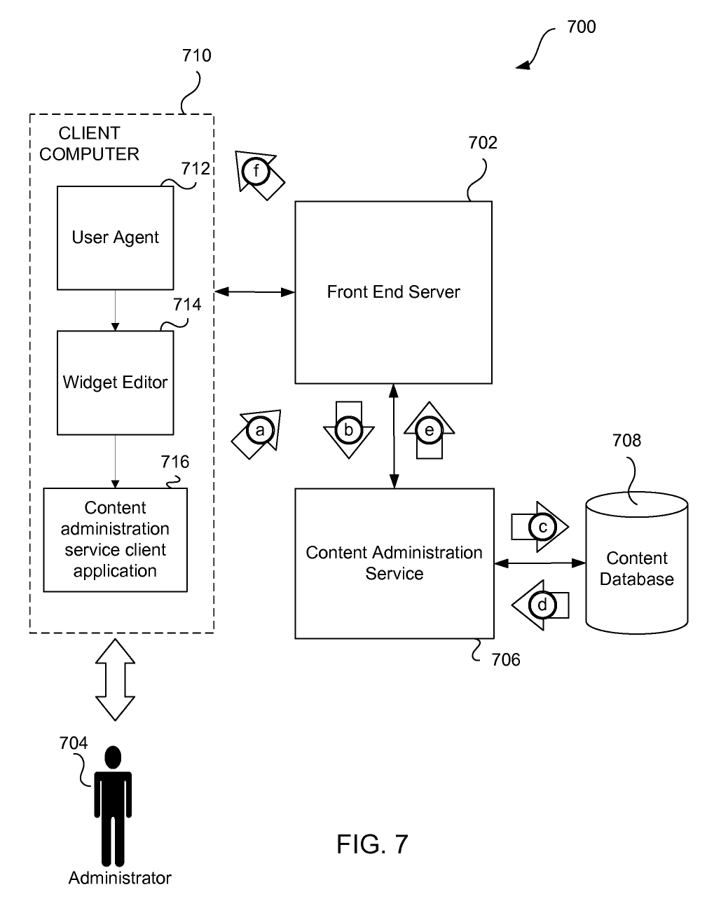

FIG. 7 is a block diagram of an exemplary client-server system 700 for editing online content according to one embodiment of the invention. The exemplary client-server system 700 for editing online content can be an implementation of the systems and/or methods described above.

The exemplary client-server system 700 for editing online content uses a front end server 702 (e.g., web server) to serve online content (e.g., web pages) to an administrator 704. The front end server 702 can also serve online content to other, non-administrators, for example end-user customers who wish to view one or more web pages. However, the online content served to end-users and to administrators can be different.

The exemplary client-server system 700 is shown in FIG. 7 as including steps (a)-(f), shown as labeled arrows, to describe the operations that occur when the administrator 704 requests online content from the front end server 702.

The exemplary client-server system 700 can further include a content administration service 706 (which can be implemented by a server computer). The content administration service 706 can act as a communications agent between the front end server 702 and a content database 708. The content database 708 can store at least the content for various web pages.

The administrator 704 accesses the front end server 702 through use of a client computer 710. The client computer 710 can include a user agent 712 (e.g., a web browser), one or more component editors 714, and a content administrative service client application 716. The user agent 712, the component editors 714 and the content administrative service client application 709 can be separate applications or applets running on the client computer 710, or can be combined into one or more applications.

The exemplary client-server system 700 is shown in a state where, at step (a), the administrator 704 requests enhanced online content (e.g., a web page with associated (e.g., embedded) administrative information via the user agent 712 at the client computer 710. The user agent 712 can use the content administration service client application 716 to communicate with the content administration service 706. Next, in step (b), the front end server 702 makes a request to the content administration service 706 for enhanced online content. The content administration service 706 can then access (c) the content database 708 in order to retrieve the requested enhanced online content, for example, by making one or a series of database queries. Next, the content administration service 706 receives the requested enhanced online content from the content database 708 in step (d). In step (e), the content administration service 706 responds to the front end server 702 with the requested enhanced online content. The requested enhanced online content can then be delivered to the client computer 710 at step (f). At the client computer 710, the user agent 714 can present the enhanced online content to the administrator 704. Thereafter, the administrator 704 can edit the enhanced online content with the assistance of the component editors 714.

Depending upon implementation, the request from the administrator 704 can be considered a single request or more than one request. For example, in the exemplary client-server system 700, the administrator 704 can request enhanced online content (e.g., a web page with associated (e.g., embedded) administrative information via the user agent 712 at the client computer 710 with a single request. As another example, in the exemplary client-server system 700, the administrator 704 can first request a web page (including information on how to access administrative information), and then after receiving the web page, the administrator 704 via the user agent 712 or the exemplary client-server system 700 itself can request the administrative information associated with the web page.

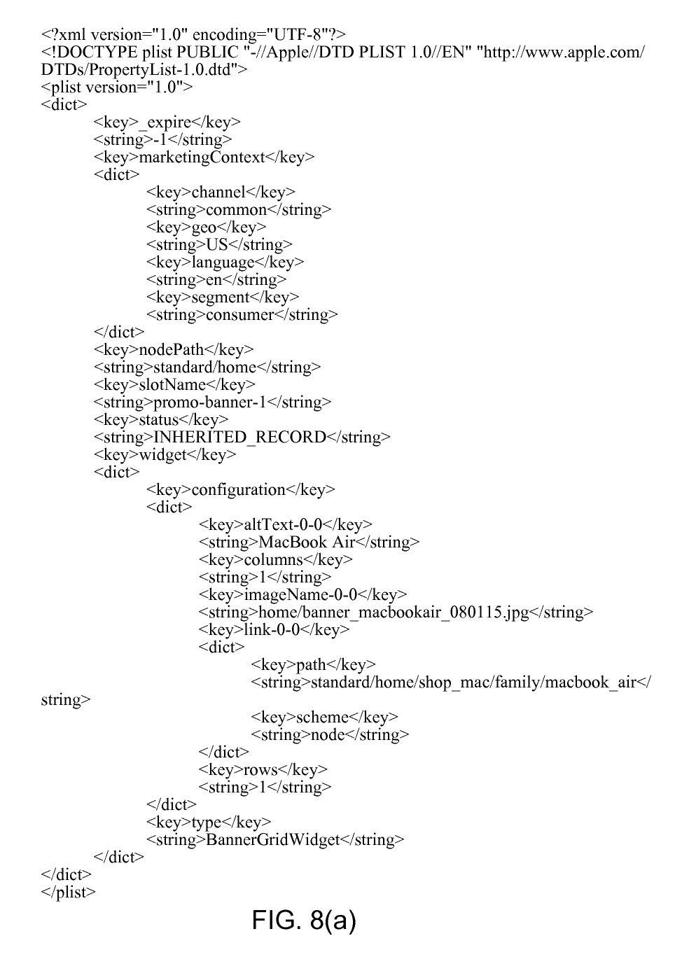

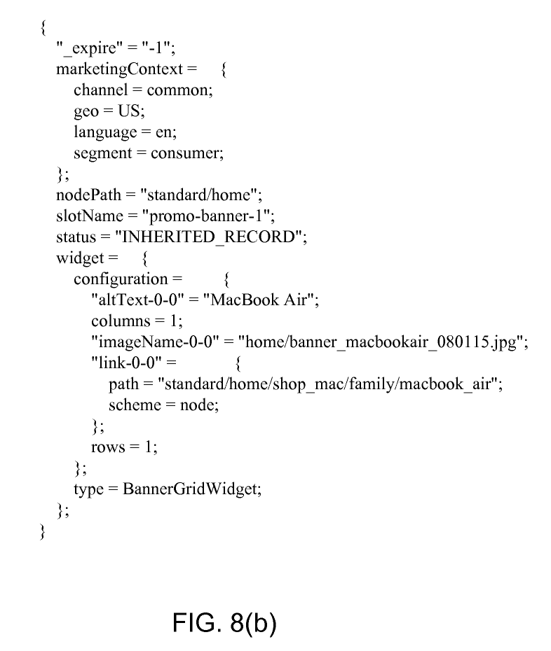

FIGS. 8(a) and 8(b) illustrate representative administrative information for a portion of a web page according to one embodiment of the invention. More particularly, FIG. 8(a) illustrates a markup language version of representative administrative information for a portion of a web page according to one embodiment of the invention, and FIG. 8(b) illustrates a property list (i.e., plist) version of the representative administrative information shown in FIG. 8(a). The markup language illustrated in FIG. 8(a) is XML. The plist version in FIG. 8(b) is provided for ease of understanding because it tends to be more human readable. The web page can have a marketing context that can be defined in the administrative information. For example, the marketing context can specify a channel, geographic region, language, and market segment for the webpage. The webpage has at least one slot that is defined in the administrative information. Namely, for the slot “promo-banner-1” the administrative information specified in FIGS. 8(a) and 8(b) provides configuration, path and type for the slot. In this example, the slot is of type “BannerGridWidget”, an image referred to as “MacBook Air” is assigned to the slot, and the path to the slot in the backend where the content for the node resides is “standard/home/shop_mac/family/macbook_air”.

The various aspects, features, embodiments or implementations of the invention described above can be used alone or in various combinations.

While this specification contains many specifics, these should not be construed as limitations on the scope of the disclosure or of what may be claimed, but rather as descriptions of features specific to particular embodiment of the disclosure. Certain features that are described in the context of separate embodiments can also be implemented in combination. Conversely, various features that are described in the context of a single embodiment can also be implemented in multiple embodiments separately or in any suitable subcombination. Moreover, although features may be described above as acting in certain combinations, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of certain embodiments of the invention is that administrators can edit web pages using a client application that causes a server application to update content data and/or configuration information remotely stored at a back-end. Advantageously, the administrators need not understand how or where the content data and/or the configuration information is stored at the back-end. Another advantage of certain embodiments of the invention is that a client application can cause an appropriate edit program to activate when a user identifies a particular component of a web page to be edited. Still another advantage of certain embodiments of the invention is that as a particular component of a web page to be edited is designated, at least a portion of configuration information associated with the particular component can be presented to the administrator.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for modifying a web page provided by a web server, where content for the web page is stored at least in part in a content database, said method comprising:
obtaining, from the web server, web page data and administrative data for at least one component of the web page, the web page data and the administrative data being stored in the content database;
editing the web page so as to modify the administrative data for the at least one component of the web page; and
submitting, to the web server, the edited web page including the modified administrative data for the at least one component of the web page.

2. A method for modifying a web page provided by a web server with content for the web server being stored at least in part to a content database, said method comprising:
accessing web page data and administrative data for at least one component of the web page, the web page data and the administrative data being stored in the content database;
subsequently receiving modified administrative data for the at least one component of the web page after the web page has been modified; and
updating the content database in view of the modified administrative data for the at least one component of the web page.

3. A method as recited in claim 2, wherein the modified administrative data is derived from the administrative data and altered in view of at least one user edit to the at least one component of the web page.

4. A computer-implemented method for editing a web page, said method comprising:
receiving a request from a requester for a web page;
obtaining web page data and stored administrative information for the requested web page, the web page having a plurality of components;
sending the web page data and the stored administrative information to the requestor;
subsequently receiving a web page edit submission to at least one of the components of the web page, the web page edit submission includes at least modified administrative information pertaining to the at least one of the components of the web page; and
updating the stored administrative information pertaining to the web page based on the modified administrative information pertaining to the at least one of the components of the web page.

5. A computer-implemented method as recited in claim 4, wherein the stored administrative information pertains to the web page is stored to a content database.

6. A computer-implemented method as recited in claim 5, wherein the administrative information provides node, slot and type for the at least one of the components of the web page.

7. A method for editing a web page, said method comprising:
requesting a web page from a web server;
receiving the web page from the web server, the web page having a plurality of components;
presenting the web page;
receiving administrative information pertaining one or more of the components of the web page;
receiving a selection of one of the components of the web page;
determining an appropriate editor for the selected component of the web page based on the administrative information pertaining to the selected component; and
accessing the appropriate editor to alter the selected component of the web page.

8. A method as recited in claim 7, wherein said receiving of administrative information comprises:
requesting administrative information for the selected component of the web page; and
receiving the administrative information for the selected component of the web page.

9. A method as recited in claim 8, wherein said method further comprises:
receiving at least one edit to the selected component of the web page via the appropriate editor; and
submitting the edit for the selected component of the web page to the web server.

10. A computer method as recited in claim 9, wherein said submitting of the edit for the web page comprises:
modifying the administrative information pertaining to at least the selected component of the web page in view of the at least one edit; and
sending the modified administrative information to the web server.

11. A computer method as recited in claim 7, wherein the appropriate editor is a WYSIWIG editing tool.

12. A computer method as recited in claim 7, wherein said method further comprises:
determining whether a pointing device indicator is hovering over a component of the web page; and
displaying at least a portion of the administrative information pertaining to the web page component if the pointing device indicator is hovering over the component of the web page.

13. A computer method as recited in claim 7, wherein said method further comprises:
receiving at least one edit to the web page via the appropriate editor; and
submitting the edit for the web page to the web server.

14. A computer method as recited in claim 7, wherein the administrative information provides node, slot and type for at least one of the components of the web page.

15. A computer-implemented method for editing a web page on a client computer, said method comprising:
requesting a web page from a web server;
receiving the web page from the web server;
receiving administrative information pertaining to the web page from the web page;
displaying the web page at the client computer;
interacting with the displayed web page to edit the web page;
modifying the administrative information based on the edit to the web page; and
submitting the edited web page to the web server, said submitting including sending the modified administrative information to the web server.

16. A computer-implemented method as recited in claim 15, wherein the administrative information comprises configuration information for a plurality of components of the web page.

17. A computer-implemented method as recited in claim 15, wherein said displaying of the web page comprises displaying the web page via a web browser operating on the client computer.

18. A computer-implemented method as recited in claim 17, wherein said interacting with the display webpage to edit the web page is performed with web browser.

19. A computer-implemented method as recited in claim 15, wherein the administrative information provides node, slot and type for at least one component of the web page.

20. A computer readable medium including at least executable computer program code tangibly stored thereon for modifying a web page provided by a web server, where content for the web page is stored at least in part in a content database, said computer readable medium comprising:
computer program code for obtaining, from the web server, web page data and administrative data for at least one component of the web page, the web page data and the administrative data being stored in the content database;
computer program code for editing the web page so as to modify the administrative data for the at least one component of the web page; and
computer program code for submitting, to the web server, the edited web page including the modified administrative data for the at least one component of the web page.

21. A computer readable medium including at least executable computer program code tangibly stored thereon for editing a web page, said computer readable medium comprising:
computer program code for receiving a request from a requestor for a web page;
computer program code for obtaining web page data and stored administrative information for the requested web page, the web page having a plurality of components;
computer program code for sending the web page data and the stored administrative information to the requestor;
computer program code for subsequently receiving a web page edit submission to at least one of the components of the web page, the web page edit submission includes at least modified administrative information pertaining to the at least one of the components of the web page; and
computer program code for updating the stored administrative information pertaining to the web page based on the modified administrative information pertaining to the at least one of the components of the web page.

22. A website content delivery and management system, comprising:
a front-end server configured to receive page requests for web pages via a network; and
a content database configured to store content for a plurality of web pages as well as administrative information pertaining to a plurality of components of the web pages,
wherein in response to a particular page request, the front-end server can return not only content for the particular web page retrieved from the content database but also administrative information associated with the particular web page, and
wherein the administrative information for the particular webpage is used to facilitate editing the particular web page.

23. A website content delivery and management system as recited in claim 22,
wherein said front-end server further determine whether the particular page request has an administrative context,
wherein the response to the particular page request from the front-end server includes the content for the particular web page without the administrative information if the particular page request does not have the administrative context, and
wherein the response to the particular page request from the front-end server includes the content for the particular web page with the administrative information if the particular page request has the administrative context.
